(19) United States
(12) Patent Application Publication
(10) Pub. No.: US 2021/0002467 A1
(43) Pub. Date: Jan. 7, 2021

(54) PROCESS FOR FUNCTIONALIZATION OF ORGANO-METAL COMPOUNDS WITH SILYL-BASED FUNCTIONALIZATION AGENTS AND SILYL-FUNCTIONALIZED COMPOUNDS PREPARED THEREBY

(71) Applicant: Dow Global Technologies LLC, Midland, MI (US)

(72) Inventors: Matthias Ober, Midland, MI (US); Longyan Liao, Midland, MI (US); Jasson T. Patton, Midland, MI (US); Sukrit Mukhopadhyay, Midland, MI (US); Jerzy Klosin, Midland, MI (US); David D. Devore, Midland, MI (US)

(21) Appl. No.: 16/982,514

(22) PCT Filed: Mar. 18, 2019
(86) PCT No.: PCT/US2019/022779

§ 371 Date: Sep. 18, 2020

Related U.S. Application Data
(60) Provisional application No. 62/644,624, filed on Mar. 19, 2018.

(51) Int. Cl. C08L 23/26; C07F 3/02; C07F 7/08; C07F 3/04; C07F 3/06; C07F 5/02; C07F 5/06; C08F 8/42

(52) U.S. Cl. CPC C08L 23/26; C07F 3/02; C07F 7/0805; C08F 8/42; C07F 3/06; C07F 5/022; C07F 5/062; C07F 3/04

(57) ABSTRACT

A process to functionalized organo-metal compounds with silyl-based electrophiles. The process includes combining an organo-metal compound, a silyl-based functionalization agent, and an optional solvent. Functionalized silanes and silyl-terminated polyolefins can be prepared by this process.

### CROSS-REFERENCE TO RELATED APPLICATIONS

The present application claims the benefit of priority to U.S. provisional patent application No. 62/644,624, filed on Mar. 19, 2018, which is hereby incorporated by reference in its entirety.

### FIELD

Embodiments relate to a process to functionalize organo-metal compounds with silyl-based electrophiles, as well as silyl-functionalized compounds prepared thereby. In at least one aspect, such a process may be conducted at elevated temperatures.

### BACKGROUND

In recent years, advances in polymer design have been seen with the use of compositions capable of chain shuttling and/or chain transfer. For example, chain shuttling agents having reversible or partial reversible chain transfer ability with transition metal catalysts have enabled the production of novel olefin block copolymers (OBCs). Typical compositions capable of chain shuttling and/or chain transfer are simple metal alkyls, such as diethyl zinc and triethyl aluminum. During chain shuttling polymerization, organo-metal compounds can be produced as intermediates, including but not limited to compounds having the formula R₂Zn or R₃Al, with R being an oligo- or polymeric substituent. Depending on conditions, these organo-metal compounds may be poor nucleophiles and may not be nucleophilic enough to react with electrophiles.

### SUMMARY

In certain embodiments, the present disclosure is directed to a process for preparing a silyl-functionalized compound, the process comprising combining starting materials comprising:

(A) an organo-metal; and

(B) a silyl-based functionalization agent,

thereby forming a product comprising a silyl-functionalized compound.

The silyl-functionalized compounds of the present disclosure may be silyl-terminated polyolefin compositions or hydrocarbylsilanes.

### BRIEF DESCRIPTION OF DRAWINGS

FIGS. 1, 2, and 3 provide the ¹H NMR, ¹³C NMR, and GCMS spectra, respectively, of Example 1.

FIGS. 4, 5, and 6 provide the ¹H NMR, ¹³C NMR, and GCMS spectra, respectively, of Example 2.

FIGS. 7 and 8 provide the ¹H NMR and ¹³C NMR spectra, respectively, of Comparative Example A.

FIG. 9 provides the ¹H NMR spectra of Comparative Example B.

FIGS. 10 and 11 provide the ¹H NMR and ¹³C NMR spectra, respectively, of Comparative Example C.

FIGS. 12 and 13 provide the ¹H NMR and ¹³C NMR spectra, respectively, of Comparative Example D.

FIG. 14 provides the ¹H NMR spectra of Comparative Example E.

### DETAILED DESCRIPTION

Despite the decreased reactivity of certain nucleophilic reactions in non-polar solvents and at low concentrations, the present disclosure is directed to a surprising and unexpected process for converting organo-metal compounds into new oligomers or polyolefins having at least one terminal end containing at least one silicon atom. In certain embodiments, the process of the present disclosure is conducted at elevated temperatures. Accordingly, in certain embodiments, the present disclosure is directed to the functionalization of metal-terminated oligomers or polymers at conditions relevant to a production process.

In certain embodiments, the present disclosure is directed to a process for preparing a silyl-terminated polyolefin composition, wherein the process comprises 1) combining starting materials comprising (A) an organo-metal and (B) a silyl-based functionalization agent, thereby obtaining a product comprising the silyl-terminated polyolefin composition. In further embodiments, the starting materials of the process may further comprise (C) a solvent.

Step 1) of combining the starting materials may be performed by any suitable means, such as mixing at a temperature of 20° C. to 250° C., or 20° C. to 220° C., or 100° C. to 180° C. Heating may be performed under inert, dry conditions. In certain embodiments, step 1) of combining the starting materials may be performed for a duration of 15 minutes to 50 hours. In further embodiments, step 1) of combining the starting materials may be performed by solution processing (i.e., dissolving and/or dispersing the starting materials in a solvent and heating) or melt extrusion (e.g., when a solvent is not used or is removed during processing).

The process may optionally further comprise one or more additional steps. For example, the process may further comprise: 2) recovering the silyl-terminated polyolefin composition. Recovering may be performed by any suitable means known in the art, such as precipitation or filtration.

In certain embodiments, the amount of each starting material depends on various factors, including the specific selection of each starting material. However, in certain embodiments, a molar excess of starting material (B) may be used per molar equivalent of starting material (A). For example, the molar ratio of the (B) silyl-based functionalization agent to the (A) organo-metal may be from 20:1 to 1:1, or from 5:1 to 1:1, or from 3.5:1 to 1.5:1. The amount of (C) solvent will depend on various factors, including the selection of starting materials (A) and (B). However, the amount of (C) solvent may be 65% to 95% based on combined weight of all starting materials used in step 1).

### (A) Organo-Metal

Starting material (A) of the process described herein is an organo-metal comprising a compound having the formula (I) or (II):

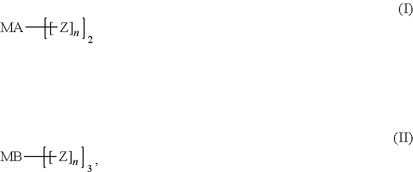

wherein:

MA is a divalent metal selected from the group consisting of Zn, Mg, and Ca;

MB is a trivalent metal selected from the group consisting of Al, B and Ga; and

each Z comprises a linear, branched, or cyclic C₁ to C₂₀ hydrocarbyl group that is substituted or unsubstituted and is aliphatic or aromatic, wherein Z optionally includes at least one substituent selected from the group consisting of a substituted or unsubstituted metal atom, a substituted or unsubstituted heteroatom, a substituted or unsubstituted aryl group, and a substituted or unsubstituted cyclic alkyl group,

each subscript n is a number from 1 to 100,000, and

the organo-metal has a molecular weight of less than or equal to 10,000 kDa.

In certain embodiments, each Z is a substituted or unsubstituted alkyl or alkenyl group selected from the group consisting of a methyl group, an ethyl group, a vinyl group, an unsubstituted phenyl group, a substituted phenyl group, a propyl group, an allyl group, a butyl group, a butenyl group, a pentyl group, a pentenyl group, a hexyl group, a hexenyl group, a heptyl group, a heptenyl group, an octyl group, an octenyl group, a nonyl group, a nonenyl group, a decyl group, a decenyl group, and any linear or cyclic isomer thereof.

In further embodiments, the organo-metal is a polymeryl-metal. Accordingly, the process of the present disclosure may optionally further comprise: forming a polymeryl-zinc before step 1) by a process comprising combining starting materials comprising:

i) a chain shuttling agent,

ii) a procatalyst,

iii) an activator, and

iv) at least one monomer, thereby obtaining a solution or slurry containing the polymeryl-metal.

The starting materials for forming a polymeryl-metal may further comprise optional materials, such as solvents and/or scavengers. The process for forming a polymeryl-metal may be performed under polymerization process conditions known in the art, including but not limited to those disclosed in U.S. Pat. Nos. 7,858,706 and 8,053,529, which are hereby incorporated by reference. Such a process for forming a polymeryl-metal essentially increases the subscript n in the formulas (I) and (II).

In certain embodiments, the process may optionally further comprise: recovering the polymeryl-metal before step 1). Recovering may be performed by any suitable means such as filtration and/or washing with a hydrocarbon solvent. Alternatively, the solution or slurry prepared as described above may be used to deliver starting material (A), i.e., the solution or slurry may be combined with starting materials comprising (B) the silyl-based functionalization agent in step 1) of the process described above.

In certain embodiments, the i) chain shuttling agent may have the formula XₓM, where M may be a metal atom from group 1, 2, 12, or 13 of the Period Table of Elements, each X is independently a monovalent hydrocarbyl group of 1 to 20 carbon atoms, and subscript x is 1 to the maximum valence of the metal selected for M. In certain embodiments, M may be a divalent metal, including but not limited to Zn, Mg, and Ca. In certain embodiments, M may be a trivalent metal, including but not limited to Al, B, and Ga. In further embodiments, M may be either Zn or Al. The monovalent hydrocarbyl group of 1 to 20 carbon atoms may be alkyl group exemplified by ethyl, propyl, octyl, and combinations thereof. Suitable chain shuttling agents include but are not limited to those disclosed in U.S. Pat. Nos. 7,858,706 and 8,053,529, which are hereby incorporated by reference.

In further embodiments, the i) chain shuttling agent may be a dual-headed chain shuttling agent. Suitable dual-headed chain shuttling agents include but are not limited to those disclosed in PCT Application Nos. PCT/US17/054458, PCT/US17/054431, and PCT/US17/054443, as well as U.S. Application Nos. 62/611,656 and 62/611,680, which are all hereby incorporated by reference.

In certain embodiments, the (ii) procatalyst may be any compound or combination of compounds capable of, when combined with an activator, polymerization of unsaturated monomers. One or more procatalysts may be used. For example, first and second olefin polymerization procatalysts may be used for preparing polymers differing in chemical or physical properties. Both heterogeneous and homogeneous procatalysts may be employed. Examples of heterogeneous procatalysts include Ziegler-Natta compositions, especially Group 4 metal halides supported on Group 2 metal halides or mixed halides and alkoxides and chromium or vanadium based procatalysts. Alternatively, for ease of use and for production of narrow molecular weight polymer segments in solution, the procatalysts may be homogeneous procatalysts comprising an organometallic compound or metal complex, such as compounds or complexes based on metals selected from Groups 3 to 15 or the Lanthanide series of the Periodic Table of the Elements.

Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2.

Suitable procatalysts include but are not limited to the following structures labeled as procatalysts (A1) to (A8):

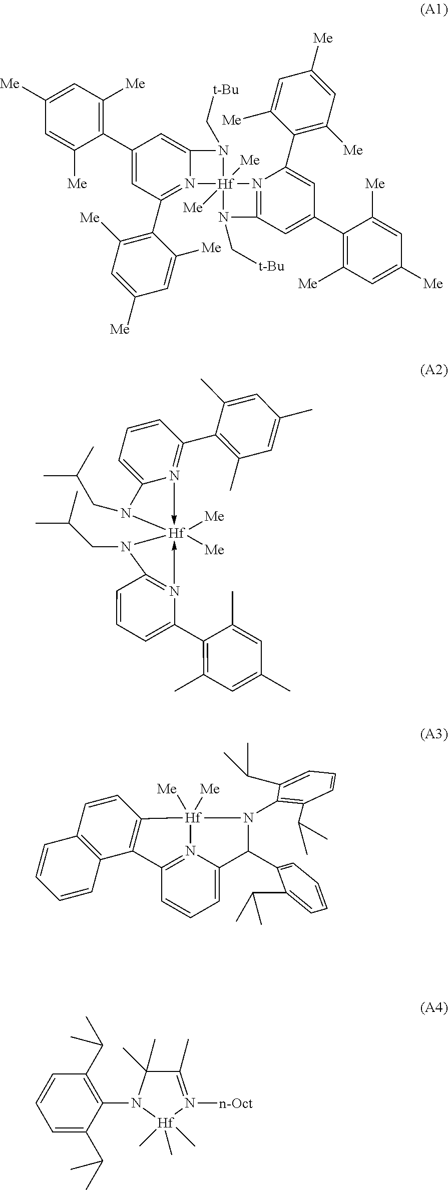

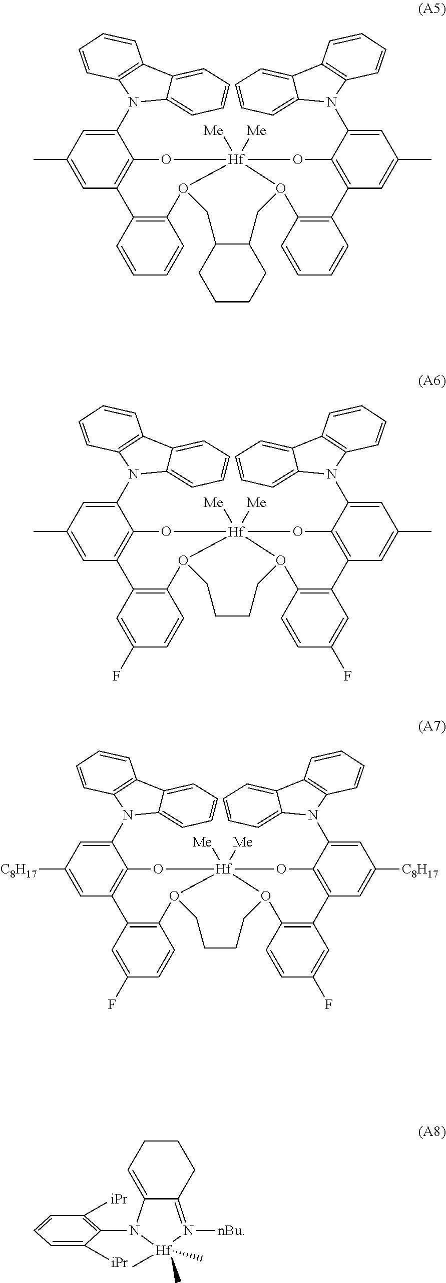

Procatalysts (A1) and (A2) may be prepared according to the teachings of WO 2017/173080 A1 or by methods known in the art. Procatalyst (A3) may be prepared according to the teachings of WO 03/40195 and U.S. Pat. No. 6,953,764 B2 or by methods known in the art. Procatalyst (A4) may be prepared according to the teachings of Macromolecules (Washington, D.C., United States), 43(19), 7903-7904 (2010) or by methods known in the art. Procatalysts (A5), (A6), and (A7) may be prepared according to the teachings of WO 2018/170138 A1 or by methods known in the art. Procatalyst (A8) may be prepared according to the teachings of WO 2011/102989 A1 or by methods known in the art.

In certain embodiments, the (iii) activator may be any compound or combination of compounds capable of activating a procatalyst to form an active catalyst composition or system. Suitable activators include but are not limited to Brønsted acids, Lewis acids, carbocationic species, or any activator known in the art, including but limited to those disclosed in WO 2005/090427 and U.S. Pat. No. 8,501,885 B2. In exemplary embodiments of the present disclosure, the co-catalyst is [(C₁₆₋₁₈H₃₃₋₃₇)₂CH₃NH] tetrakis(pentafluorophenyl)borate salt.

In certain embodiments, the (iii) at least one monomer includes any addition polymerizable monomer, generally any olefin or diolefin monomer. Suitable monomers can be linear, branched, acyclic, cyclic, substituted, or unsubstituted. In one aspect, the olefin can be any α-olefin, including, for example, ethylene and at least one different copolymerizable comonomer, propylene and at least one different copolymerizable comonomer having from 4 to 20 carbons, or 4-methyl-1-pentene and at least one different copolymerizable comonomer having from 4 to 20 carbons. Examples of suitable monomers include, but are not limited to, straight-chain or branched α-olefins having from 2 to 30 carbon atoms, from 2 to 20 carbon atoms, or from 2 to 12 carbon atoms. Specific examples of suitable monomers include, but are not limited to, ethylene, propylene, 1-butene, 1-pentene, 3-methyl-1-butene, 1-hexane, 4-methyl-1-pentene, 3-methyl-1-pentene, 1-octene, 1-decene, 1-dodecene, 1-tetradecene, 1-hexadecene, 1-octadecene, and 1-eicosene. Suitable monomers also include cycloolefins having from 3 to 30, from 3 to 20 carbon atoms, or from 3 to 12 carbon atoms. Examples of cycloolefins that can be used include, but are not limited to, cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene. Suitable monomers also include di- and poly-olefins having from 3 to 30, from 3 to 20 carbon atoms, or from 3 to 12 carbon atoms. Examples of di- and poly-olefins that can be used include, but are not limited to, butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidene norbornene, vinyl norbornene, dicyclopentadiene, 7-methyl-1,6-octadiene, 4-ethylidene-8-methyl-1,7-nonadiene, and 5,9-dimethyl-1,4,8-decatriene. In a further aspect, aromatic vinyl compounds also constitute suitable monomers for preparing the copolymers disclosed here, examples of which include, but are not limited to, mono- or poly-alkylstyrenes (including styrene, o-methylstyrene, m-methylstyrene, p-methylstyrene, o,p-dimethylstyrene, o-ethylstyrene, m-ethylstyrene and p-ethylstyrene), and functional group-containing derivatives, such as methoxystyrene, ethoxystyrene, vinylbenzoic acid, methyl vinylbenzoate, vinylbenzyl acetate, hydroxystyrene, o-chlorostyrene, p-chlorostyrene, divinylbenzene, 3-phenylpropene, 4-phenylpropene and α-methylstyrene, vinylchloride, 1,2-difluoroethylene, 1,2-dichloroethylene, tetrafluoroethylene, and 3,3,3-trifluoro-1-propene, provided the monomer is polymerizable under the conditions employed.

In certain embodiments, the polymeryl-metal prepared as described above may be but is not limited to di-polyethylene zinc, di-poly(ethylene/octene) zinc, tri-polyethylene aluminium, tri-poly(ethylene/octene) aluminum and mixtures thereof.

The organo-metal used as starting material (A) may comprise of any or all embodiments discussed herein.

### (B) Silyl-Based Functionalization Agent

Starting material (B) used in the process of the present disclosure is a silyl-based functionalization agent having the formula XSi(R^{K})₃, wherein:
each R^{K} is independently X, a hydrogen atom, or a substituted or unsubstituted C₁ to C₂₅ hydrocarbyl group, wherein at least one R^{K} is a hydrogen atom;
X is a leaving group selected from the group consisting of a halogen, a mesylate, a triflate, a tosylate, a fluorosulfonate, an N-bound five or six membered N-heterocyclic ring, an O-bound acetimide radical that is further substituted at a nitrogen atom, an N-bound acetimide radical that is optionally further substituted at an oxygen atom and/or at an nitrogen atom, an O-bound trifluoroacetimide radical that is further substituted at a nitrogen atom, an N-bound trifluoroacetimide radical that is optionally further substituted at an oxygen atom and/or a nitrogen atom, a dialkylazane, a silylalkylazane, or an alkyl-, allyl- or aryl sulfonate; and
the Si atom has a free volume parameter of greater than or equal to 0.43.

“An N-bound five or six membered N-heterocyclic ring” includes but is not limited to a pyridine (i.e., a pyridinium radical cation), N-bound substituted pyridine (i.e., substituted pyridinium radical cation, including but not limited to p-N,N-dialkylamino pyridinium radical cation), imidazole, and a 1-methyl-3λ²-imidazol-1-ium radical cation.

In certain embodiments, when R^{K} is a substituted or unsubstituted C₁ to C₂₅ hydrocarbyl group, R^{K} comprises between 0 and 3 oxygen atoms, between 0 and 1 sulfur atoms, and between 0 and 1 nitrogen atoms, wherein the free volume parameter of the Si atom of the formula XSi(R^{K})₃ is greater than or equal to 0.43.

In further embodiments, the (B) silyl-based functionalization agent having the formula XSi(R^{K})₃ is further defined by the formula (III):

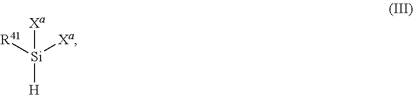

wherein:

each X^{a} is independently a hydrogen atom or X as defined above, wherein at least one X^{a} is X as defined above, and

R⁴¹ is selected from the group consisting of a substituted or unsubstituted alkyl or alkenyl group selected from the group consisting of a methyl group, an ethyl group, a vinyl group, an unsubstituted phenyl group, a substituted phenyl group, a propyl group, an allyl group, a butyl group, a butenyl group, a pentyl group, a pentenyl group, a hexyl group, a hexenyl group, a heptyl group, a heptenyl group, an octyl group, an octenyl group, a nonyl group, a nonenyl group, a decyl group, a decenyl group, and any linear or cyclic isomer thereof.

In further embodiments, the (B) silyl-based functionalization agent having the formula XSi(R^{K})₃ is selected from the group consisting of:

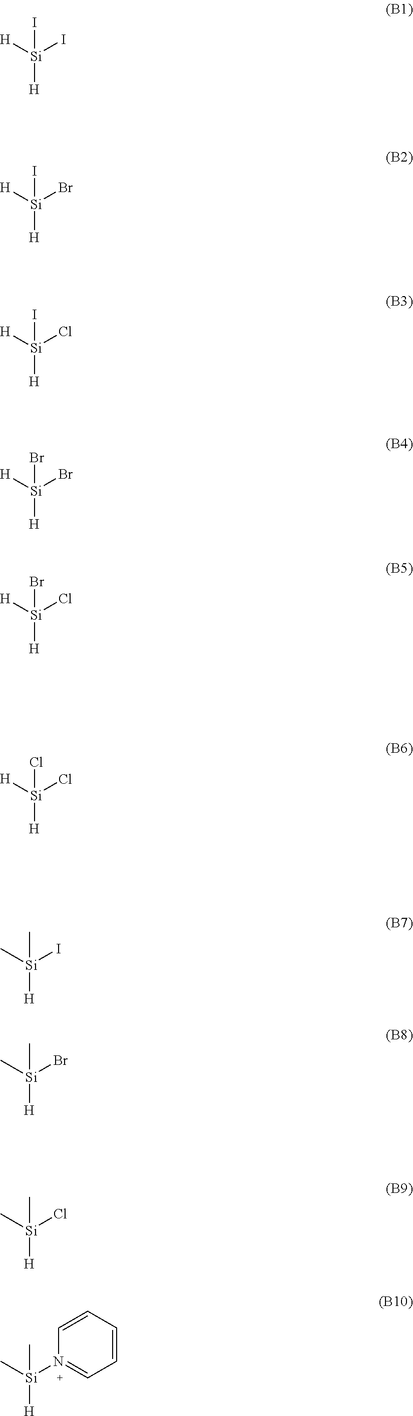

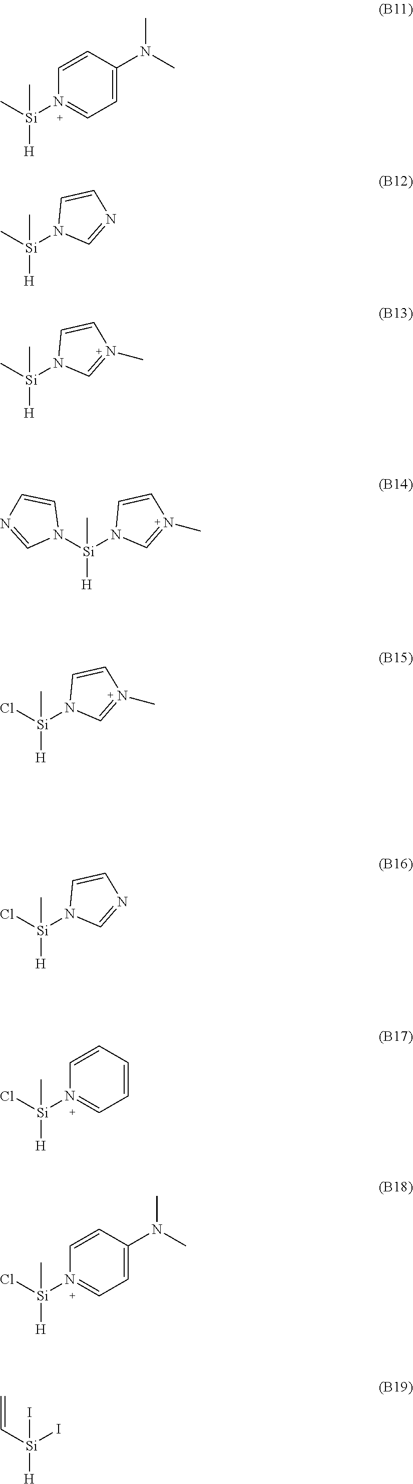

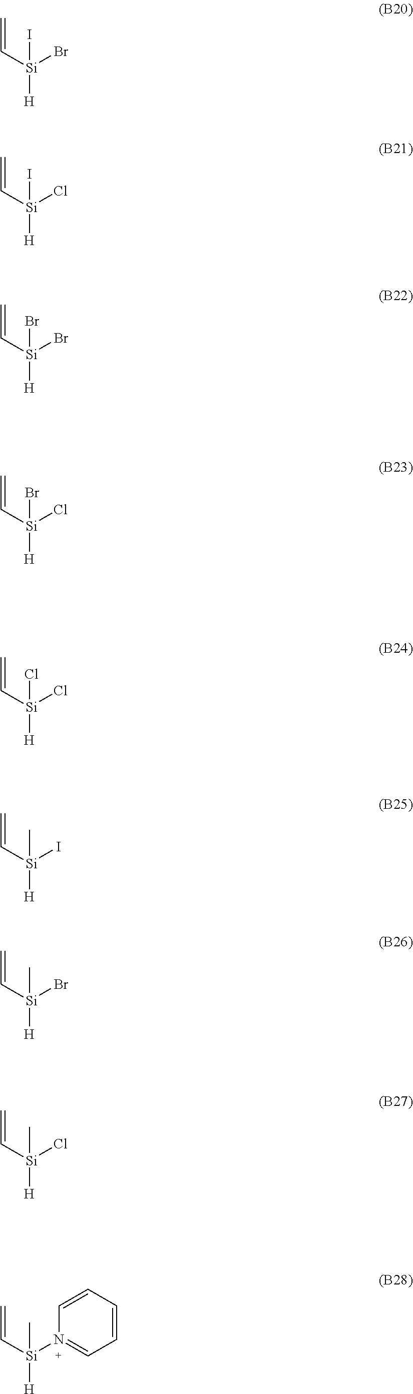

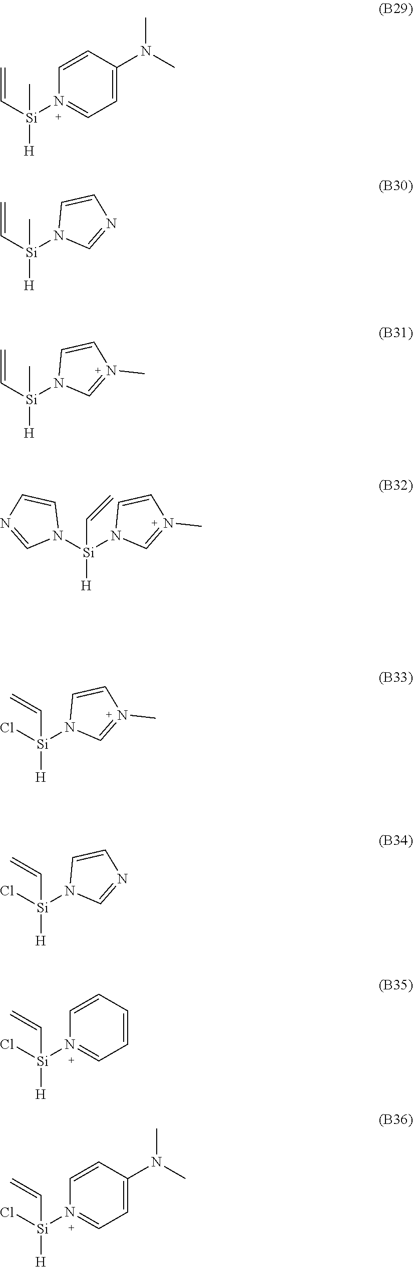

Without being bound by any theory, the inventors of the present disclosure have surprisingly and unexpectedly discovered that converting organo-metal compounds into new oligomers or polyolefins having at least one terminal end containing at least one silicon atom may be possible if a silyl-based functionalization agent having a Si atom with a free volume parameter greater than or equal to 0.43 is used.

Without being bound by any theory, the inventors of the present disclosure have surprisingly and unexpectedly discovered that use of a silyl-based functionalization agent containing a silicon atom having a free volume parameter of greater than or equal to 0.43 facilitates functionalization of an organo-metal compound. In other words, the inventors of the present disclosure have surprisingly and unexpectedly discovered that adding a silyl-based functionalization agent facilitates functionalization of an organo-metal compound where the silyl-based functionalization agent contains at least one silicon bonded hydrogen per molecule.

The silyl-based functionalization agent used as starting material (B) may comprise of any or all embodiments discussed herein.

### (C) Solvent

Starting material (C), a solvent may optionally be used in step 1) of the process described above. Suitable solvents include but are not limited to a non-polar aliphatic or aromatic hydrocarbon solvent selected from the group of pentane, hexane, heptane, octane, nonane, decane, undecane, dodecane, cyclopentane, methylcyclopentane, cyclohexane, methylchyclohexane, cycloheptane, cyclooctane, decalin, benzene, toluene, xylene, an isoparaffinic fluid including but not limited to Isopar™ E, Isopar™ G, Isopar™ H, Isopar™ L, Isopar™ M, a dearomatized fluid including but not limited to Exxsol™ D or isomers and mixtures thereof. Alternatively, the solvent may be toluene and/or Isopar™ E.

The amount of solvent added depends on various factors including the type of solvent selected and the process conditions and equipment that will be used.

### Product

The present process described herein results in a silyl-terminated polyolefin composition comprising a compound of the formula (IV):

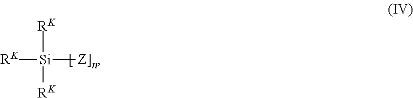

wherein each of Z, subscript n, and R^{K} are as defined above, and wherein at least one R^{K} is a hydrogen atom.

In certain embodiments, the silyl-terminated polyolefin composition prepared by the present process further comprises a metal compound comprising a divalent metal or a trivalent metal. This metal compound can be of the type MA(X^{a})₂ or a metal salt MB(X^{a})₃ (with X^{a} being defined herein), oxides or hydroxides of MA or MB and hydrates thereof.

Silyl-terminated polyolefin compositions prepared using the present process may have a silyl group at one end of the polymer chain. Silyl-terminated polyolefins that may be prepared as described herein include silyl-terminated polyethylenes, silyl-terminated polypropylenes, silyl-terminated polybutylenes, silyl-terminated poly (1-butene), silyl-terminated polyisobutene, silyl-terminated poly(l-pentene), silyl-terminated poly(3-methyl-1-pentene), silyl-terminated poly(4-methyl-1-hexene), and silyl-terminated poly(5-methyl-1-hexene).

In certain embodiments, the silyl-terminated polyolefins prepared using the process described above is a mono-SiH terminated polyolefin. Alternatively, the silyl-terminated polyolefin may be dimethyl,hydrogensilyl-terminated polyethylene; dimethyl,hydrogensilyl-terminated poly(ethylene/octene) copolymer; diphenylhydrogensilyl-terminated polyethylene; diphenylhydrogensilyl-terminated poly(ethylene/octene) copolymer; phenyldihydrogensilyl-terminated polyethylene; phenyldihydrogensilyl-terminated poly(ethylene/octene) copolymer; chlorophenylhydrogensilyl-terminated polyethylene; or chlorophenylhydrogensilyl-terminated poly(ethylene/octene) copolymer.

In certain embodiments, the silyl-terminated polyolefin compositions of the present disclosure may be intermediates used to prepare novel block copolymers, including but not limited to PE-Si-PDMS block copolymers.

### Definitions

All references to the Periodic Table of the Elements refer to the Periodic Table of the Elements published and copyrighted by CRC Press, Inc., 1990. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight and all test methods are current as of the filing date of this disclosure. For purposes of United States patent practice, the contents of any referenced patent, patent application or publication are incorporated by reference in their entirety (or its equivalent U.S. version is so incorporated by reference in its entirety), especially with respect to the disclosure of synthetic techniques, product and processing designs, polymers, catalysts, definitions (to the extent not inconsistent with any definitions specifically provided in this disclosure), and general knowledge in the art.

Number ranges in this disclosure are approximate and, thus, may include values outside of the ranges unless otherwise indicated. Number ranges include all values from and including the lower and the upper values, including fractional numbers or decimals. The disclosure of ranges includes the range itself and also anything subsumed therein, as well as endpoints. For example, disclosure of a range of 1 to 20 includes not only the range of 1 to 20 including endpoints, but also 1, 2, 3, 4, 6, 10, and 20 individually, as well as any other number subsumed in the range. Furthermore, disclosure of a range of, for example, 1 to 20 includes the subsets of, for example, 1 to 3, 2 to 6, 10 to 20, and 2 to 10, as well as any other subset subsumed in the range.

Similarly, the disclosure of Markush groups includes the entire group and also any individual members and subgroups subsumed therein. For example, disclosure of the Markush group a hydrogen atom, an alkyl group, an alkenyl group, or an aryl group, includes the member alkyl individually; the subgroup hydrogen, alkyl and aryl; the subgroup hydrogen and alkyl; and any other individual member and subgroup subsumed therein.

In the event the name of a compound herein does not conform to the structural representation thereof, the structural representation shall control.

The term “comprising” and derivatives thereof means including and is not intended to exclude the presence of any additional component, starting material, step or procedure, whether or not the same is disclosed therein.

The terms “group,” “radical,” and “substituent” are also used interchangeably in this disclosure.

The term “hydrocarbyl” means groups containing only hydrogen and carbon atoms, where the groups may be linear, branched, or cyclic, and, when cyclic, aromatic or non-aromatic.

The term “substituted” means that a hydrogen group has been replaced with a hydrocarbyl group, a heteroatom, or a heteroatom containing group. For example, methyl cyclopentadiene (Cp) is a Cp group substituted with a methyl group and ethyl alcohol is an ethyl group substituted with an —OH group.

The term “leaving group” is a molecular fragment that departs with a pair of electrons in heterolytic bond cleavage.

The term “free volume parameter” refers to the volume of the van der Waals sphere (determined as fraction) on the Si-atom that is not covered by the same from the substituents, attached to it.

The terms “polymer,” “polymer,” and the like refer to a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, homogeneous, heterogeneous, etc.

“Interpolymer” and “copolymer” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

### EXAMPLES

### Methods

¹H NMR:

¹H NMR spectra are recorded on a Bruker AV-400 spectrometer at ambient temperature. ¹H NMR chemical shifts in benzene-d₆ are referenced to 7.16 ppm (C₆D₅H) relative to TMS (0.00 ppm).

¹³C NMR:

¹³C NMR spectra of polymers are collected using a Bruker 400 MHz spectrometer equipped with a Bruker Dual DUL high-temperature CryoProbe. The polymer samples are prepared by adding approximately 2.6 g of a 50/50 mixture of tetrachloroethane-d₂/orthodichlorobenzene containing 0.025M chromium trisacetylacetonate (relaxation agent) to 0.2 g of polymer in a 10 mm NMR tube. The samples are dissolved and homogenized by heating the tube and its contents to 150° C. The data is acquired using 320 scans per data file, with a 7.3 second pulse repetition delay with a sample temperature of 120° C.

GC/MS:

Tandem gas chromatography/low resolution mass spectroscopy using electron impact ionization (EI) is performed at 70 eV on an Agilent Technologies 6890N series gas chromatograph equipped with an Agilent Technologies 5975 inert XL mass selective detector and an Agilent Technologies Capillary column (HP1MS, 15 m×0.25 mm, 0.25 micron) with respect to the following:

Programmed method:

Oven Equilibration Time 0.5 min

50° C. for 0 min

then 25° C./min to 200° C. for 5 min

Run Time 11 min

Molecular Weight:

Molecular weights are determined by optical analysis techniques including deconvoluted gel permeation chromatography coupled with a low angle laser light scattering detector (GPC-LALLS) as described by Rudin, A., “Modem Methods of Polymer Characterization”, John Wiley & Sons, New York (1991) pp. 103-112.

Free Volume Parameter:

Ground-state geometries of all the molecules are optimized using restricted (closed shell) hybrid Density Functional Theory (DFT), Becke, 3-parameter, Lee-Yang-Parr (B3LYP) (Becke, A. D. J. Chem. Phys. 1993, 98, 5648; Lee, C. et al., Phys. Rev B 1988, 37, 785; and Miehlich, B. et al. Chem. Phys. Lett. 1989, 157, 200) and the 6-31G** basis set (Ditchfield, R. et al., J. Chem. Phys. 1971, 54, 724; Hehre, W. J. et al., J. Chem. Phys. 1972, 56, 2257; and Gordon, M. S. Chem. Phys. Lett. 1980, 76, 163). The effect of dielectric medium is incorporated using the conductor like polarizable continuum model (cpcm); cyclohexane is chosen to represent the medium. The minimum of the ground-state potential energy surface (PES) is verified by the lack of imaginary frequency in the optimized ground-state conformation. All the calculations were performed using G09 suite of programs (Frisch, M. J.; Trucks, G. W.; Schlegel, H. B.; Scuseria, G. E.; Robb, M. A.; Cheeseman, J. R.; Scalmani, G.; Barone, V.; Mennucci, B.; Petersson, G. A.; Nakatsuji, H.; Caricato, M.; Li, X.; Hratchian, H. P.; Izmaylov, A. F.; Bloino, J.; Zheng, G.; Sonnenberg, J. L.; Hada, M.; Ehara, M.; Toyota, K.; Fukuda, R.; Hasegawa, J.; Ishida, M.; Nakajima, T.; Honda, Y.; Kitao, O.; Nakai, H.; Vreven, T.; Montgomery, J. A., Jr.; Peralta, J. E.; Ogliaro, F.; Bearpark, M.; Heyd, J. J.; Brothers, E.; Kudin, K. N.; Staroverov, V. N.; Kobayashi, R.; Normand, J.; Raghavachari, K.; Rendell, A.; Burant, J. C.; Iyengar, S. S.; Tomasi, J.; Cossi, M.; Rega, N.; Millam, J. M.; Klene, M.; Knox, J. E.; Cross, J. B.; Bakken, V.; Adamo, C.; Jaramillo, J.; Gomperts, R.; Stratmann, R. E.; Yazyev, O.; Austin, A. J.; Cammi, R.; Pomelli, C.; Ochterski, J. W.; Martin, R. L.; Morokuma, K.; Zakrzewski, V. G.; Voth, G. A.; Salvador, P.; Dannenberg, J. J.; Dapprich, S.; Daniels, A. D.; Farkas, O.; Foresman, J. B.; Ortiz, J. V.; Cioslowski, J.; Fox, D. J. Gaussian, Inc., Wallingford Conn., 2009.)

Once the optimized geometry of a silyl-based functionalization agent is obtained, a sphere of radius 2.5 Å is placed around the Si atom. The total volume of this sphere is denoted as V₁. This is followed by placing spheres on other atoms; the radii of these spheres are chosen to be the van der Waals radii of respective atoms. The volume of the sphere centered on Si, which is occluded by spheres on other atoms are computed using Monte carlo integration technique (V₂). The free volume (FV) is calculated using the following equation 1:

FV=1−(V₂/V₁) Eq. 1

The FV descriptor varies between 0 and 1. This technique is implemented using Pipeline Pilot tool kit. This procedure is used in literature to understand bond dissociation trends (Albert Poater, Biagio Cosenza, Andrea Correa, Simona Giudice, Francesco Ragone, Vittorio Scarano and Luigi Cavallo, Eur. J. Inorg. Chem. 2009, 1759 (2009)).

### Preparation of Reagents

Synthesis of Iododimethyl(Vinyl)Silane:

In a nitrogen-filled glove box, a mixture of chlorodimethyl(vinyl)silane (1.0 mL, 7.2 mmol) and lithium iodide (0.97 g, 7.2 mmol) is stirred overnight at room temperature. The mixture is then filtered to give a colorless liquid (1.2 g, 78% yield). ¹H NMR (400 MHz, Toluene-d8) δ 6.03 (dd, J=20.0, 14.4 Hz, 1H), 5.67 (dd, J=14.3, 2.7 Hz, 1H), 5.56 (dd, J=20.0, 2.9 Hz, 1H), 0.56 (s, 6H). ¹³C NMR (101 MHz, toluene) δ 135.94, 133.53, 2.96. ¹H NMR analysis shows 93% conversion of the intended reaction (see Reaction Scheme A).

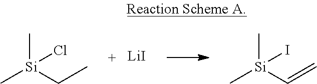

Synthesis of Dimethyl(Vinyl)Silyl Trifluoromethanesulfonate:

In a nitrogen-filled glove box, a mixture of chlorodimethyl(vinyl)silane (2.04 mL, 14.8 mmol) and silver trifluoromethanesulfonate (3.8 g, 14.8 mmol) is stirred at room temperature for 18 hours. The mixture is then filtered to give a colorless oil (1.9 g, 55% yield). ¹H NMR (400 MHz, Chloroform-d) δ 6.21 (m, 2H), 5.99 (dd, J=18.4, 5.1 Hz, 1H), 0.54 (s, 6H). ¹³C NMR (101 MHz, cdcl3) δ 137.71, 131.89, 118.25 (q, J=317 Hz) (the peaks are 122.99, 119.83, 116.67, 113.52), −1.69 (t, J=31 Hz), (the peaks are −1.39, −1.69, −2.00). ¹H NMR analysis shows complete conversion of the intended reaction (see Reaction Scheme B).

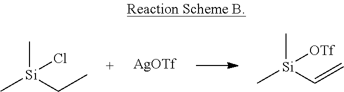

Synthesis of Iododimethylsilane:

In a nitrogen-filled glove box, a mixture of chlorodimethylsilane (5.0 mL, 45.0 mmol) and lithium iodide (6.03 g, 45.0 mmol) is stirred at room temperature for 18 hours. The mixture is then filtered to yield a pale yellow oil (5.8 g, 69% yield). ¹H NMR (400 MHz, Toluene-d8) δ 4.57 (hept, J=3.4 Hz, 1H), 0.49 (d, J=10.8 Hz, 6H). ¹³C NMR (101 MHz, toluene) δ 0.92. ¹H NMR analysis shows 92% conversion of the intended reaction (see Reaction Scheme C).

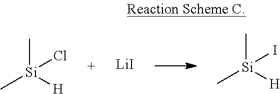

### Example 1

Reaction of Dioctyl Zinc with Iododimethylsilane:

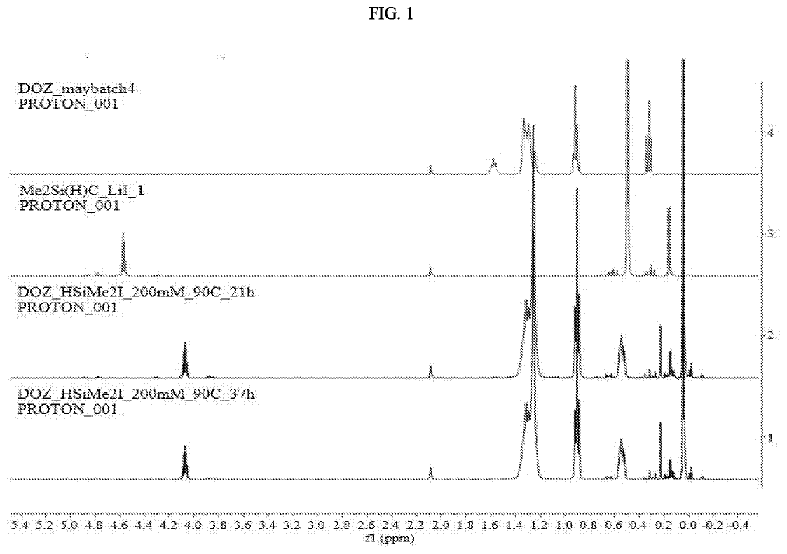

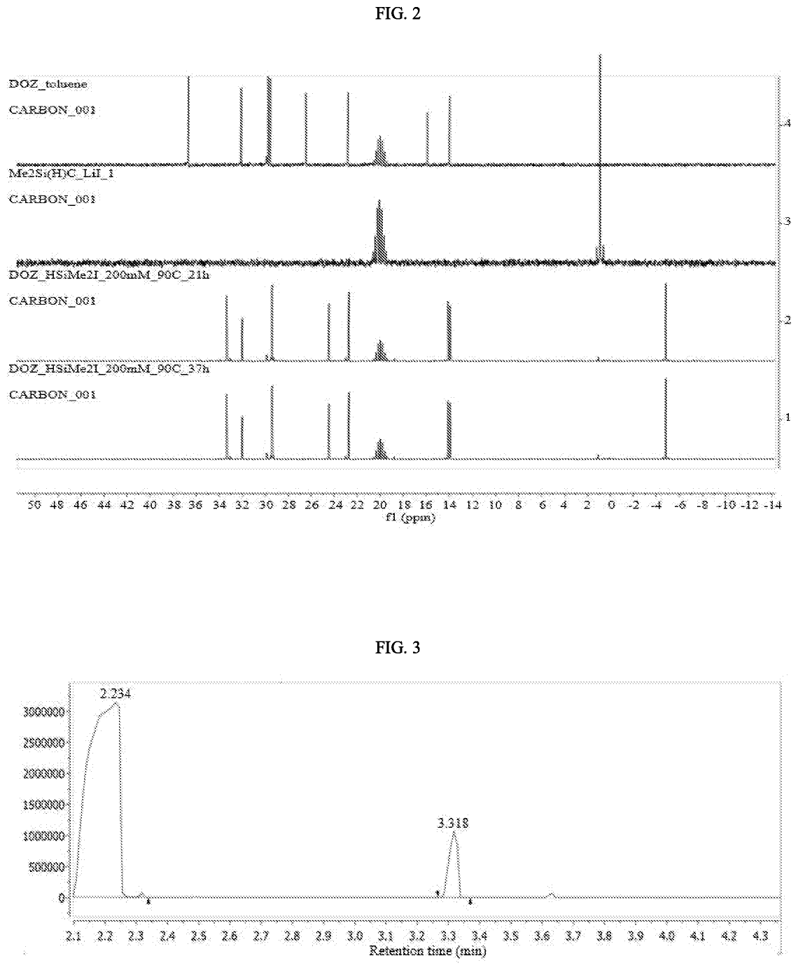

In a nitrogen-filled glove box, iododimethylsilane (90% purity, 57 mg, 0.28 mmol) having a free volume parameter of 0.46, dioctyl zinc (40 mg, 0.14 mmol), and 0.684 mL toluene-d8 are added and mixed in a 7.0 mL glass vial equipped with a stir bar. The reaction mixture is well mixed and then transferred into an NMR tube. The tube is then placed in a heating block at 90° C. ¹H NMR and ¹³C NMR are taken at the reaction times of 21 hours and 37 hours, as seen in FIGS. 1 and 2, respectively, and as follows: ¹H NMR (400 MHz, Toluene-d8) δ 4.07 (h, J=3.5 Hz, 1H), 1.42-1.16 (m, 12H), 0.90 (t, J=6.8 Hz, 3H), 0.60-0.49 (m, 2H), 0.04 (d, J=3.7, 6H). ¹³C NMR (101 MHz, toluene) δ 33.35, 32.01, 29.44, 29.39, 24.46, 22.73, 14.11, 13.92, −4.80. In addition, the final solution is submitted to GCMS, as seen in FIG. 3.

Specifically, FIG. 1 provides a top ¹H NMR spectrum of dioctyl zinc, a second from the top ¹H NMR spectrum of iododimethylsilane, a third from the top ¹H NMR spectrum of the reaction mixture at 21 hours, and a bottom ¹H NMR spectrum of the reaction mixture at 27 hours. FIG. 2 provides a top ¹³C NMR spectrum of dioctyl zinc, a second from the top ¹³C NMR spectrum of iododimethylsilane, a third from the top ¹³C NMR spectrum of the reaction mixture at 21 hours, and a bottom ¹³C NMR spectrum of the reaction mixture at 37 hours. FIG. 3 provides GCMS results where the top spectrum is the TIC trace of the crude reaction sample and the bottom spectrum is the MS spectrum of the peak at 3.32 min.

As seen in FIG. 1, ¹H NMR analysis shows there is complete conversion of dioctyl zinc at 21 hours, as indicated by β-H at 1.58 ppm, and complete conversion of iododimethylsilane, as indicated by Si—H at 4.57 ppm. There is negligible change between the 21 hour and 37 hour time points. As seen in FIG. 2, ¹³C NMR also shows complete conversion of dioctyl zinc and iododimethylsilane with negligible change between the 21 hour and 37 hour time points. As seen in FIG. 3, GCMS has a clean trace with the desired product peak at retention time of 3.32 min. Accordingly, ¹H NMR, ¹³C NMR, and GCMS analyses confirm that the reaction shown in Reaction Scheme D proceeds as intended. Thus, use of a silyl-based functionalization agent having a free volume parameter of greater than or equal to 0.43 allows for functionalization of an organo-metal compound.

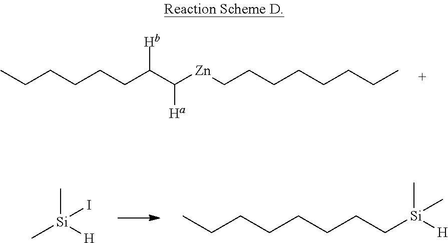

### Example 2

Reaction of Trioctyl Aluminum with Iododimethylsilane:

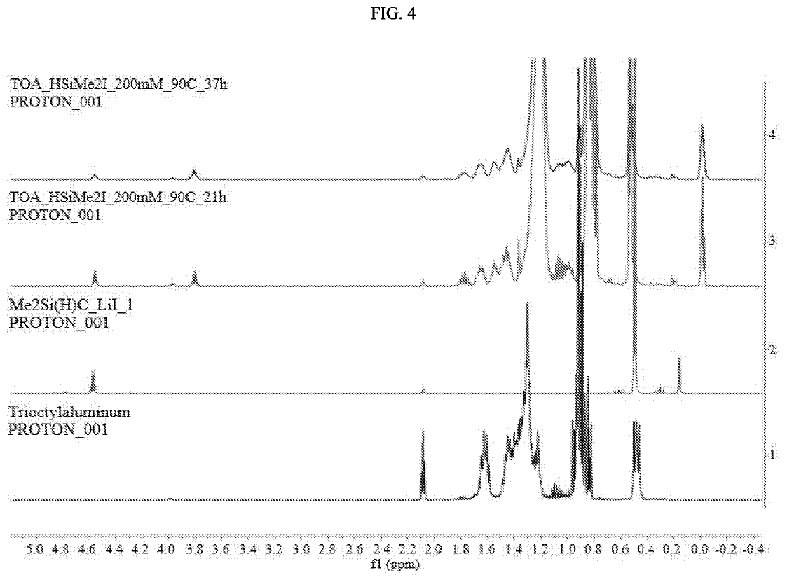

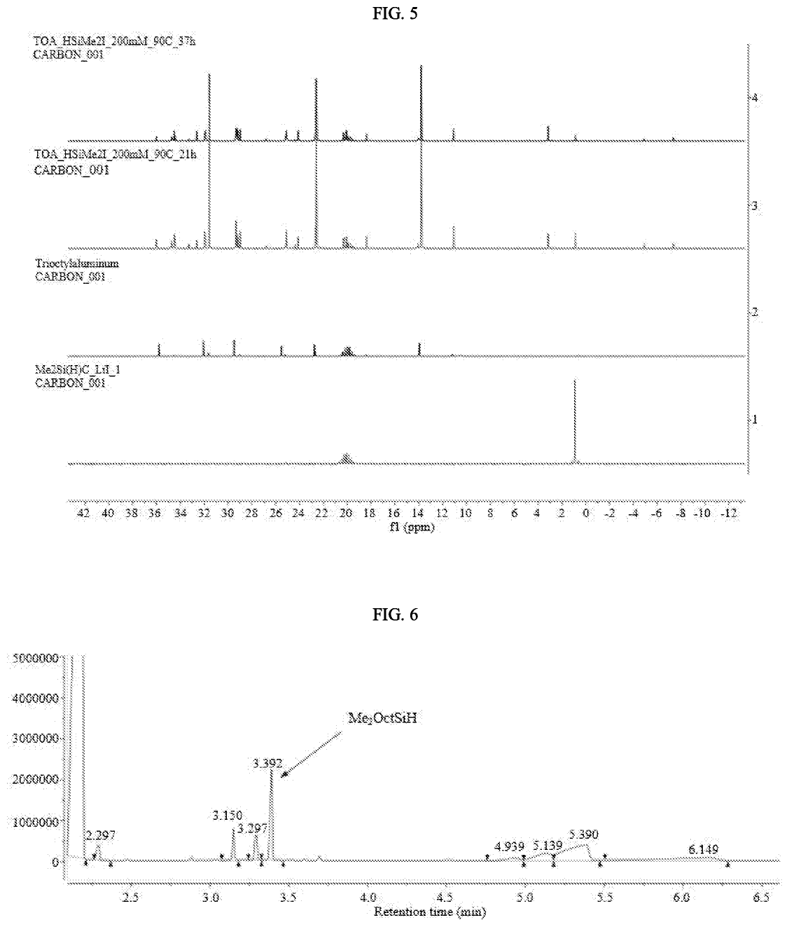

In a nitrogen-filled glove box, iododimethylsilane (90% pure, 74 mg, 0.36 mmol) having a free volume parameter of 0.46, trioctyl aluminum (25 wt % in hexanes, 0.25 mL, 0.12 mmol), and 347.4 μL of toluene-d8 are added and mixed in a 7.0 mL glass vial equipped with a stir bar. The reaction mixture is well mixed and then transferred into an NMR tube. The tube is placed in a heating block at 90° C. ¹H NMR and ¹³C NMR are taken at the reaction times of 21 hours and 37 hours, as seen in FIGS. 4 and 5, respectively. In addition, the final solution is submitted to GCMS, as seen in FIG. 6.

Specifically, FIG. 4 provides a top ¹H NMR spectrum of the reaction mixture at 37 hours, a second from the top ¹H NMR spectrum of the reaction mixture at 21 hours, a third from the top ¹H NMR spectrum of iododimethylsilane, and a bottom ¹H NMR spectrum of trioctyl aluminum.

FIG. 5 provides a top ¹³C NMR spectrum of the reaction mixture at 37 hours, a second from the top ¹³C NMR spectrum of the reaction mixture at 21 hours, a third from the top ¹³C NMR spectrum of iododimethylsilane, and a bottom ¹³C NMR spectrum of trioctyl aluminum. FIG. 6 provides GCMS spectra where the top spectrum is a TIC trace of the crude reaction sample and the bottom spectrum is the MS spectrum of the peak at 3.39 min (product peak).

¹H NMR, ¹³C NMR, and GCMS analyses confirm that the reaction shown in Reaction Scheme E proceeds as intended. Thus, use of a silyl-based functionalization agent having a free volume parameter of greater than or equal to 0.43 allows for functionalization of an organo-metal compound.

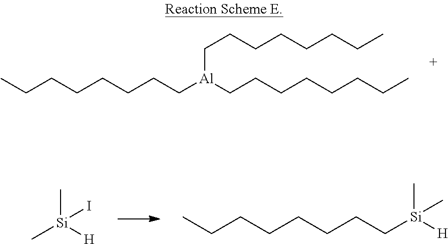

### Comparative Example A

Reaction of Dioctyl Zinc with Dimethyl(Vinyl)Silyl Chloride:

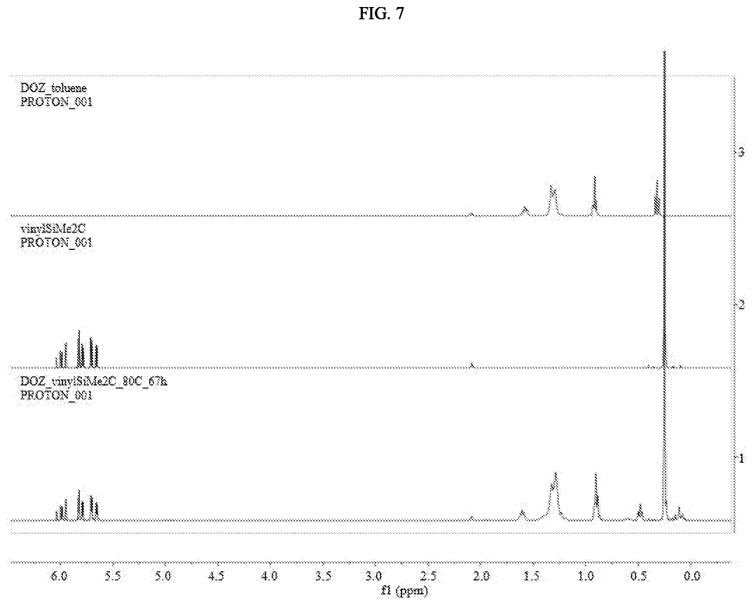

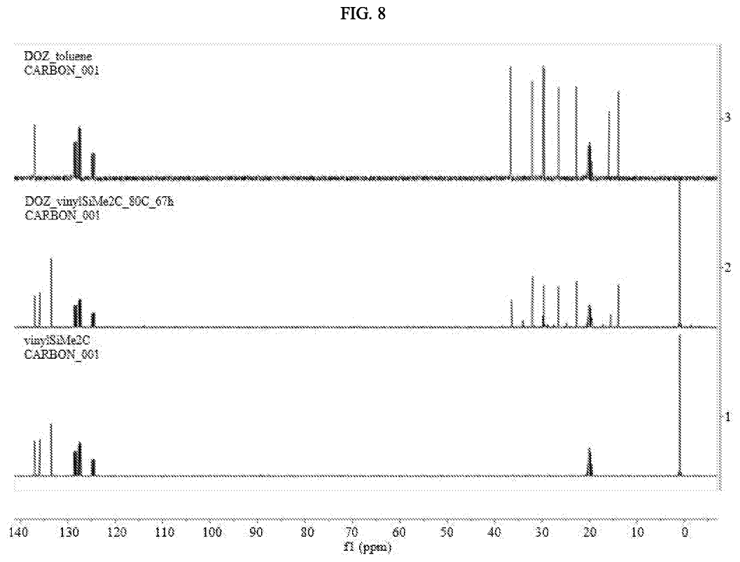

In a nitrogen-filled glove box, dimethyl(vinyl)silyl chloride (95 μL, 0.68 mmol) having a free volume parameter of 0.35, dioctyl zinc (100 mg, 0.34 mmol), and 1.82 mL toluene-d8 are added and mixed in a 7.0 mL glass vial equipped with a stir bar. This reaction mixture is stirred at 80° C. for 67 hours. At 67 hours, there is no precipitate formed, and the liquid of the reaction mixture is taken out for NMR analysis as seen in FIGS. 7 and 8. Specifically, FIG. 7 provides a top ¹H NMR spectrum of dioctyl zinc, a middle ¹H NMR spectrum of dimethyl(vinyl)silyl chloride, and a bottom ¹H NMR spectrum of the reaction mixture at 67 hours. FIG. 8 provides a top ¹³C NMR spectrum of dioctyl zinc, a middle ¹³C NMR spectrum of the reaction mixture at 67 hours, and a bottom ¹³C NMR spectrum of dimethyl(vinyl)silyl chloride.

As seen in FIG. 7, ¹H NMR shows that the β-H of dioctyl zinc (H^{b} shown below in Reaction Scheme F) at 1.58 ppm is not obviously reacted. There are no new alkene peaks observed as well. In addition, as seen in FIG. 8, ¹³CNMR shows that there is mainly unreacted starting material. Accordingly, ¹H NMR and ¹³C NMR show that the reaction does not proceed as intended, as indicated in Reaction Scheme F. Thus, use of a silyl-based functionalization agent having a free volume parameter of less than 0.43 does not result in functionalization of an organo-metal compound.

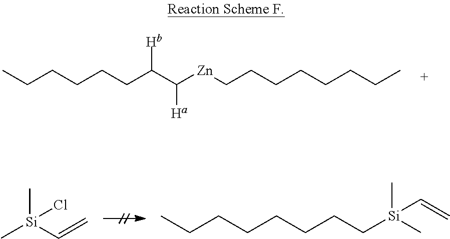

### Comparative Example B

Reaction of Dioctyl Zinc with Dimethyl(Vinyl)Silyl Iodide:

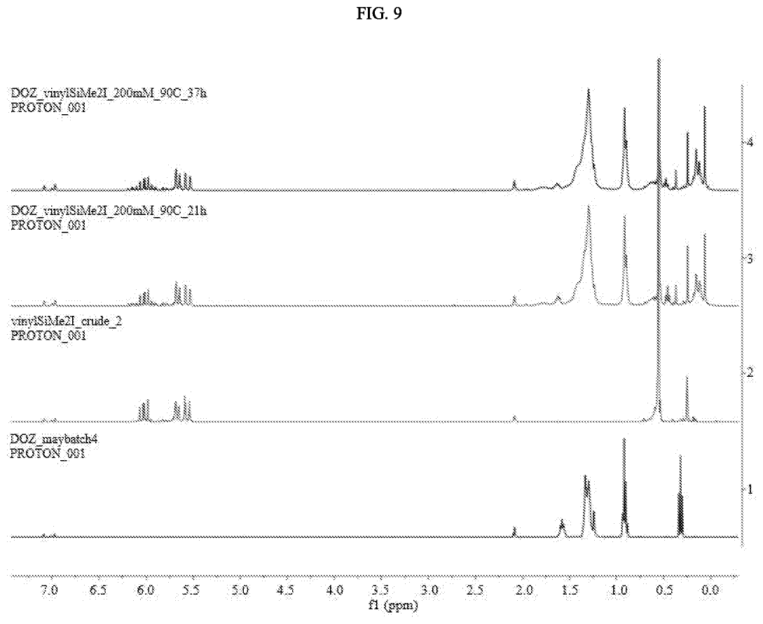

In a nitrogen-filled glove box, dimethyl(vinyl)silyl iodide (58.1 mg, 0.28 mmol) having a free volume parameter of 0.34, dioctyl zinc (40 mg, 0.14 mmol), and 0.684 mL toluene-d8 are added and mixed in a 7.0 mL glass vial equipped with a stir bar. This reaction mixture is well mixed and then transferred into an NMR tube. The tube is placed in a heating block at 90° C. ¹H NMR is taken at reaction times of 21 hours and 37 hours as seen in FIG. 9. Specifically, FIG. 9 provides a top ¹H NMR spectrum of the reaction mixture at 37 hours, a second from the top ¹H NMR spectrum of the reaction mixture at 21 hours, a third from the top ¹H NMR spectrum of dimethyl(vinyl)silyl iodide, and a bottom ¹H NMR spectrum of dioctyl zinc.

As seen in FIG. 9, ¹H NMR shows new alkene peaks at 6.15 ppm comparted to starting material at 6.02 ppm. However, the ratio of new peak to starting material goes from 1.0:4.5 at the 21 hour time point to 1.0:3.2 at the 37 hour time point. Accordingly, ¹H NMR shows that the reaction is too slow and produces insufficient yield, as indicated in Reaction Scheme G. Thus, use of a silyl-based functionalized agent having a free volume parameter of less than 0.43 does not result in practical functionalization of an organo-metal compound.

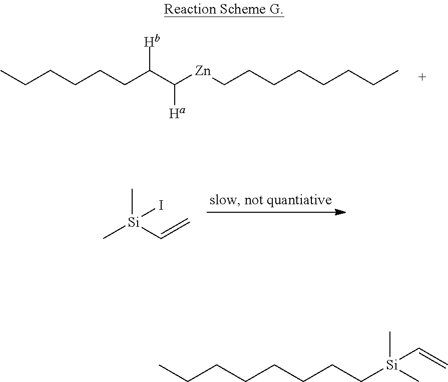

### Comparative Example C

Reaction of Dioctyl Zinc with Dimethyl(Vinyl)Silyl Trifluoromethanesulfonate:

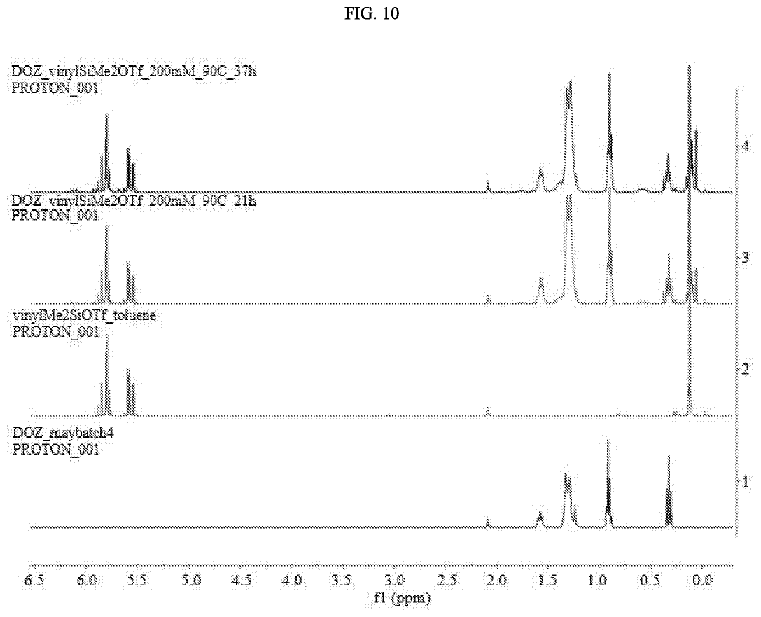

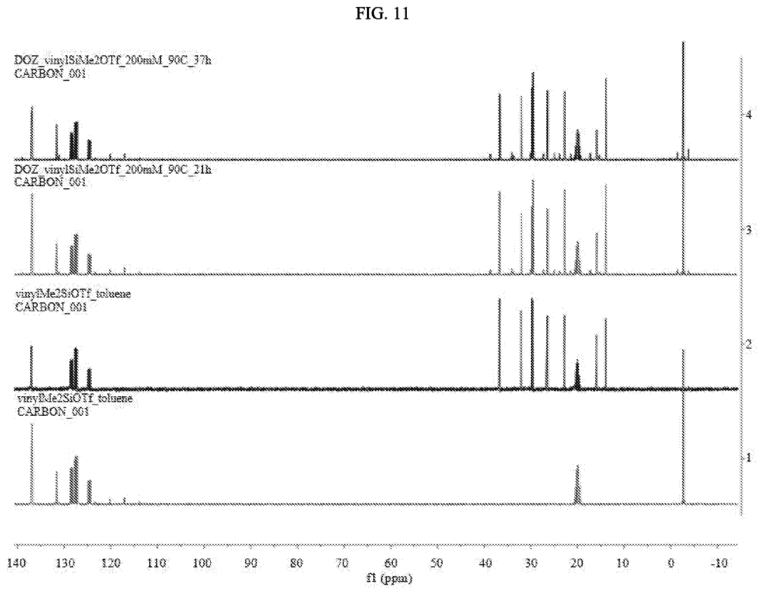

In a nitrogen-filled glove box, dimethyl(vinyl)silyl trifluoromethanesulfonate (64.2 mg, 0.28 mmol) having a free volume parameter of 0.31, dioctyl zinc (40 mg, 0.14 mmol), and 0.684 mL toluene-d8 are added and mixed in a 7.0 mL glass vial equipped with a stir bar. The reaction mixture is well mixed and then transferred into an NMR tube. The tube is placed in a heating block at 90° C. ¹H NMR and ¹³C NMR are taken at reaction times of 21 hours and 37 hours, as seen in FIGS. 10 and 11, respectively.

Specifically, FIG. 10 provides a top ¹H NMR spectrum of the reaction mixture at 37 hours, a second from the top ¹H NMR spectrum of the reaction mixture at 21 hours, a third from the top ¹H NMR spectrum of dimethyl(vinyl)silyl trifluoromethanesulfonate, and a bottom ¹H NMR spectrum of dioctyl zinc. FIG. 11 provides a top ¹³C NMR spectrum of the reaction mixture at 37 hours, a second from the top ¹³C NMR spectrum of the reaction mixture at 21 hours, a third from the top ¹³C NMR spectrum of dioctyl zinc, and a bottom ¹³C NMR spectrum of dimethyl(vinyl)silyl trifluorometahnesulfonate.

As seen in FIG. 10, ¹H NMR shows new alkene peaks of chemical shift at 6.14 ppm compared to starting material at 5.81 ppm. However, the ratio of new peak to starting material goes from 0.02:1.0 at the 21 hour time point to 0.04:1.0 at the 37 hour time point. Accordingly, ¹H NMR shows that the reaction is too slow and produces insufficient yield, as indicated in Reaction Scheme H. As seen in FIG. 11, ¹³C NMR shows new peaks as well but confirms that there is only a little conversion of starting material to desired product. Thus, use of a silyl-based functionalized agent having a free volume parameter of less than 0.43 does not result in practical functionalization of an organo-metal compound.

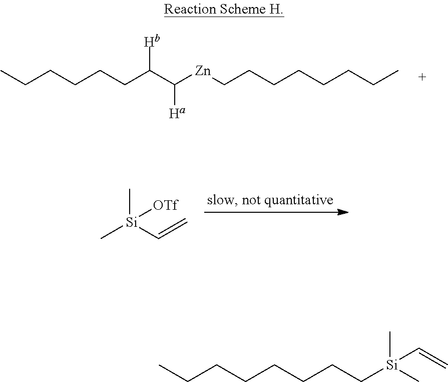

### Comparative Example D

Reaction of Trioctyl Aluminum with Dimethyl(Vinyl)Silyl Trifluoromethanesulfonate:

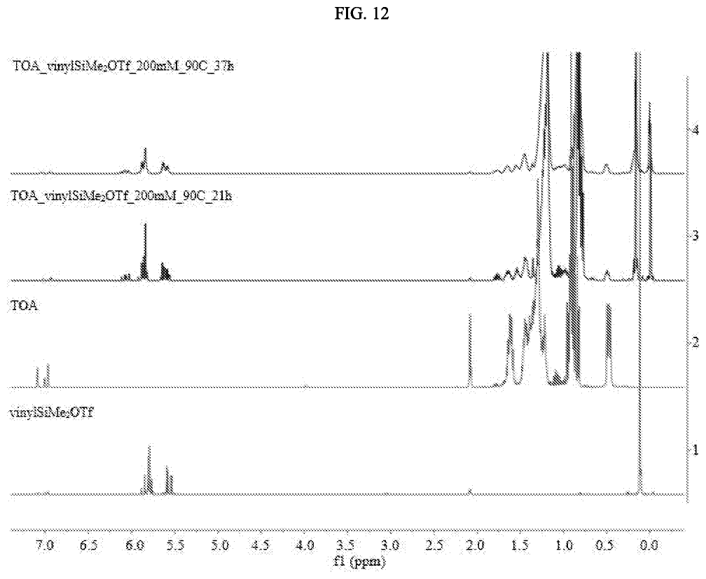

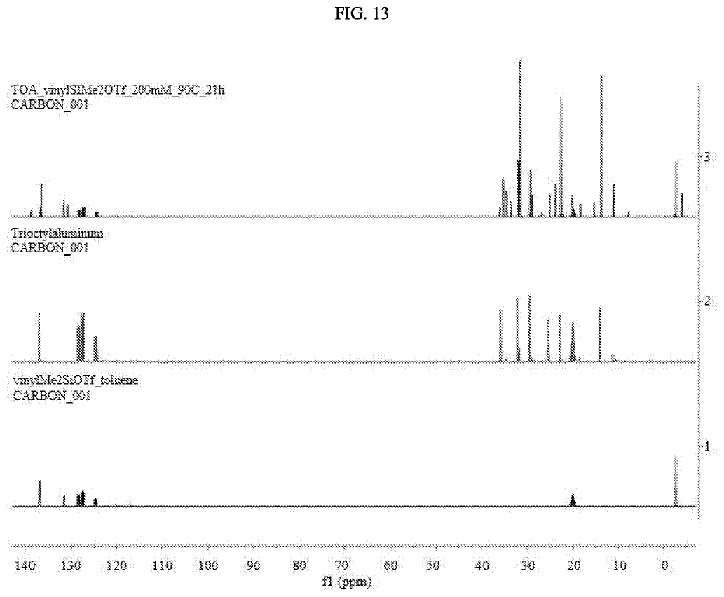

In a nitrogen-filled glove box, dimethyl(vinyl)silyl trifluoromethanesulfonate (76.7 mg, 0.33 mmol) having a free volume parameter of 0.31, trioctyl aluminum (40 mg, 0.11 mmol), and 0.545 mL toluene-d8 are added and mixed in a 7.0 mL glass vial equipped with a stir bar. The reaction mixture is well mixed and then transferred into an NMR tube. The tube is placed in a heating block at 90° C. ¹H NMR and ¹³C NMR are taken at reaction times of 21 hours and 37 hours, as seen in FIGS. 12 and 13, respectively. Specifically, FIG. 12 provides a top ¹H NMR spectrum of the reaction mixture at 37 hours, a second from the top ¹H NMR spectrum of the reaction mixture at 21 hours, a third from the top ¹H NMR spectrum of trioctyl aluminum, and a bottom ¹H NMR of dimethyl(vinyl)silyl trifluoromethanesulfonate. FIG. 13 provides a top ¹³C NMR spectrum of the reaction mixture at 21 hours, a middle ¹³C NMR spectrum of trioctyl aluminum, and a bottom ¹³C NMR spectrum of dimethyl(vinyl)silyl trifluoromethanesulfonate.

As seen in FIG. 12, ¹H NMR shows new alkene peaks of chemical shift at 6.07 ppm compared to starting material at 5.86 ppm. However, the ratio of new peak to starting material goes from 0.19:1.00 at the 21 hour time point to 0.21:1.00 at the 37 hour time point. Accordingly, ¹H NMR shows that the reaction is too slow and produces insufficient yield, as indicated in Reaction Scheme I. As seen in FIG. 13, ¹³C NMR shows new peaks as well but confirms that there is only a small amount of conversion of starting material to desired product. Thus, use of a silyl-based functionalized agent having a free volume parameter of less than 0.43 does not result in practical functionalization of an organo-metal compound.

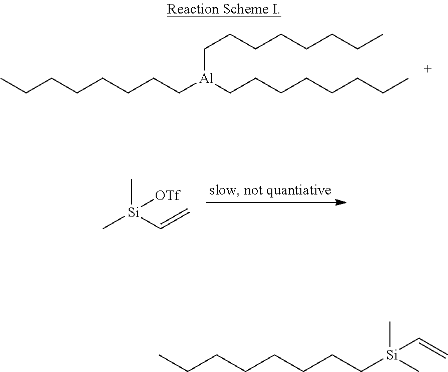

### Comparative Example E

Reaction of Dioctyl Zinc with Trimethylsilyl Iodide:

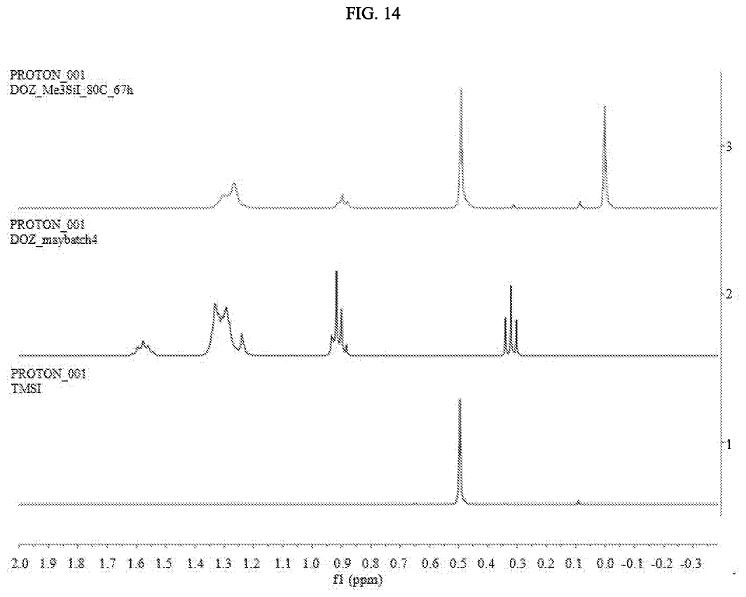

In a nitrogen-filled glove box, iodotrimethylsilane (98 μL, 0.68 mmol) having a free volume parameter of 0.34, dioctylzinc (100 mg, 0.34 mmol), and 1.82 mL toluene-d8 are added and mixed in a 7.0 mL glass vial equipped with a stir bar. This reaction mixture is stirred at 80° C. for 67 hours. At 67 hours, there is a lot of white precipitate formed, and the liquid from the reaction mixture is analyzed by NMR, as seen in FIG. 14. Specifically, FIG. 14 provides a top ¹H NMR spectrum of the reaction mixture at 67 hours, a middle ¹H NMR spectrum of dioctyl zinc, and a bottom ¹H NMR spectrum of trimethylsilyl iodide.

As seen in FIG. 14, ¹H NMR shows that dioctyl zinc is completely converted based on the peak of H^{a} 0.32 pm and H^{b} at 1.58 ppm. However, there is a good amount of trimethylsilyl iodide left (the peak at ˜0.5 ppm), indicating that there is insufficient yield for the desired reaction shown below in Reaction Scheme J. Thus, use of a silyl-based functionalized agent having a free volume parameter of less than 0.43 does not result in practical functionalization of an organo-metal compound.

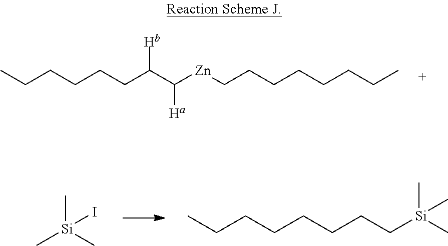

The above examples show that use of a silyl-based functionalization agent containing a silicon atom having a free volume parameter of greater than or equal to 0.43 facilitates functionalization of an organo-metal compound. In other words, the above examples show that adding a silyl-based functionalization agent facilitates functionalization of an organo-metal compound where the silyl-based functionalization agent contains at least one silicon bonded hydrogen per molecule.

What is claimed is:

1. A silyl-terminated polyolefin composition comprising a compound of the formula (IV): 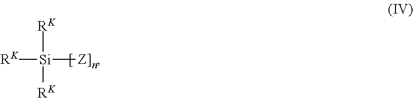
wherein
Z comprises a linear, branched, or cyclic C₁ to C₂₀ hydrocarbyl group that is substituted or unsubstituted and is aliphatic or aromatic, wherein Z optionally includes at least one substituent selected from the group consisting of a substituted or unsubstituted metal atom, a substituted or unsubstituted heteroatom, a substituted or unsubstituted aryl group, and a substituted or unsubstituted cyclic alkyl group;
subscript n is a number from 1 to 100,000;
each R^{K} is independently a hydrogen atom, a substituted or unsubstituted C₁ to C₂₅ hydrocarbyl group, or a leaving group selected from the group consisting of a halogen, a mesylate, a triflate, a tosylate, a fluorosulfonate, an N-bound five or six membered N-heterocyclic ring, an O-bound acetimide radical that is further substituted at a nitrogen atom, an N-bound acetimide radical that is optionally further substituted at an oxygen atom and/or at an nitrogen atom, an O-bound trifluoroacetimide radical that is further substituted at a nitrogen atom, an N-bound trifluoroacetimide radical that is optionally further substituted at an oxygen atom or a nitrogen atom, a dialkylazane, a silylalkylazane, or an alkyl-, allyl- or aryl sulfonate; and
at least one R^{K} is a hydrogen atom, and
wherein the silyl-terminated polyolefin composition further comprises a metal compound comprising a divalent metal or a trivalent metal.

2. The composition of claim 1, wherein Z is a substituted or unsubstituted alkyl or alkenyl group selected from the group consisting of a methyl group, an ethyl group, a vinyl group, an unsubstituted phenyl group, a substituted phenyl group, a propyl group, an allyl group, a butyl group, a butenyl group, a pentyl group, a pentenyl group, a hexyl group, a hexenyl group, a heptyl group, a heptenyl group, an octyl group, an octenyl group, a nonyl group, a nonenyl group, a decyl group, a decenyl group, and any linear or cyclic isomer thereof.

3. The composition of claim 1, wherein each of at least two R^{K} groups is a substituted or unsubstituted C₁ to C₂₅ hydrocarbyl group.

4. A process for preparing a silyl-terminated polyolefin composition, the process comprising 1) combining starting materials comprising
(A) an organo-metal; and
(B) a silyl-based functionalization agent, thereby obtaining a product comprising the silyl-terminated polyolefin composition.

5. The process of claim 4, wherein the starting materials further comprise
(C) a solvent.

6. The process of claim 4, wherein the (A) organo-metal comprises a compound having the formula (I) or (II)): 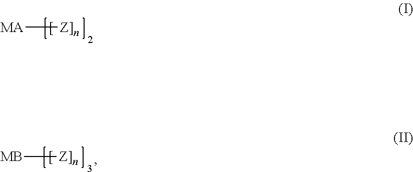
wherein
MA is a divalent metal selected from the group consisting of Zn, Mg, and Ca;
MB is a trivalent metal selected from the group consisting of Al, B and Ga; and
each Z comprises a linear, branched, or cyclic C₁ to C₂₀ hydrocarbyl group that is substituted or unsubstituted and is aliphatic or aromatic, wherein Z optionally includes at least one substituent selected from the group consisting of a substituted or unsubstituted metal atom, a substituted or unsubstituted heteroatom, a substituted or unsubstituted aryl group, and a substituted or unsubstituted cyclic alkyl group,
each subscript n is a number from 1 to 100,000, and
the organo-metal has a molecular weight of less than or equal to 10,000 kDa.

7. The process of claim 6, wherein each Z is a substituted or unsubstituted alkyl or alkenyl group selected from the group consisting of a methyl group, an ethyl group, a vinyl group, an unsubstituted phenyl group, a substituted phenyl group, a propyl group, an allyl group, a butyl group, a butenyl group, a pentyl group, a pentenyl group, a hexyl group, a hexenyl group, a heptyl group, a heptenyl group, an octyl group, an octenyl group, a nonyl group, a nonenyl group, a decyl group, a decenyl group, and any linear or cyclic isomer thereof.

8. The process of claim 6, wherein MA is Zn and MB is Al.

9. The process of claim 4, wherein the (B) silyl-based functionalization agent has the formula XSi(R^{K})₃, wherein:
each R^{K} is independently X, a hydrogen atom, or a substituted or unsubstituted C₁ to C₂₅ hydrocarbyl group, wherein at least one R^{K} is a hydrogen atom;
X is a leaving group selected from the group consisting of a halogen, a mesylate, a triflate, a tosylate, a fluorosulfonate, an N-bound five or six membered N-heterocyclic ring, an O-bound acetimide radical that is further substituted at a nitrogen atom, an N-bound acetimide radical that is optionally further substituted at an oxygen atom or at an nitrogen atom, an O-bound trifluoroacetimide radical that is further substituted at a nitrogen atom, an N-bound trifluoroacetimide radical that is optionally further substituted at an oxygen atom and/or a nitrogen atom, a dialkylazane, a silylalkylazane, or an alkyl-, allyl- or aryl sulfonate; and
the Si atom has a free volume parameter of greater than or equal to 0.43.

10. The process of claim 9, wherein the (B) silyl-based functionalization agent has the formula (III): 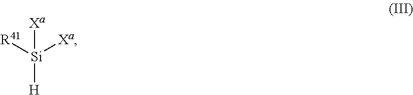
wherein:
each X^{a} is independently a hydrogen atom or the leaving group X;
at least one X^{a} is the leaving group X, and
R⁴¹ is selected from the group consisting of a substituted or unsubstituted alkyl or alkenyl group selected from the group consisting of a methyl group, an ethyl group, a vinyl group, an unsubstituted phenyl group, a substituted phenyl group, a propyl group, an allyl group, a butyl group, a butenyl group, a pentyl group, a pentenyl group, a hexyl group, a hexenyl group, a heptyl group, a heptenyl group, an octyl group, an octenyl group, a nonyl group, a nonenyl group, a decyl group, a decenyl group, and any linear or cyclic isomer thereof.

11. The process of claim 10, wherein the (B) silyl-based functionalization agent is selected from the group consisting of: 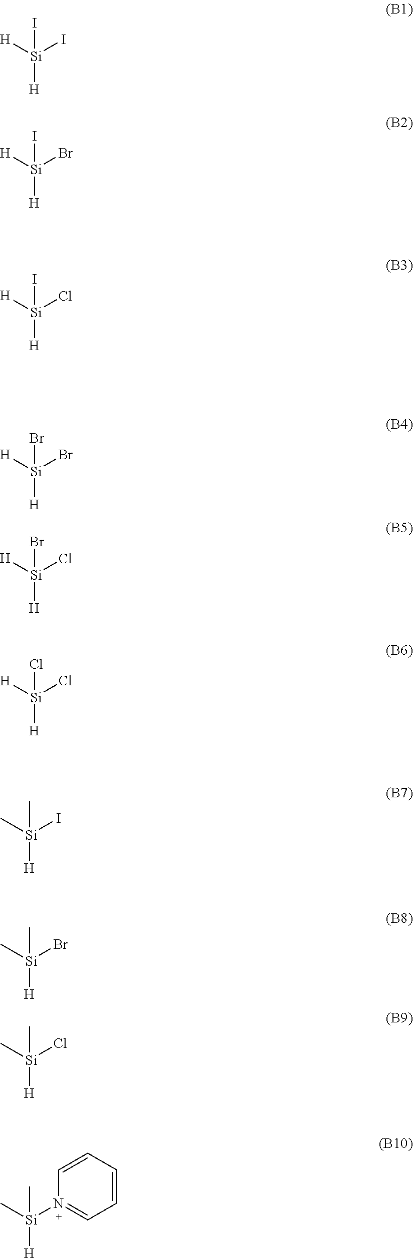 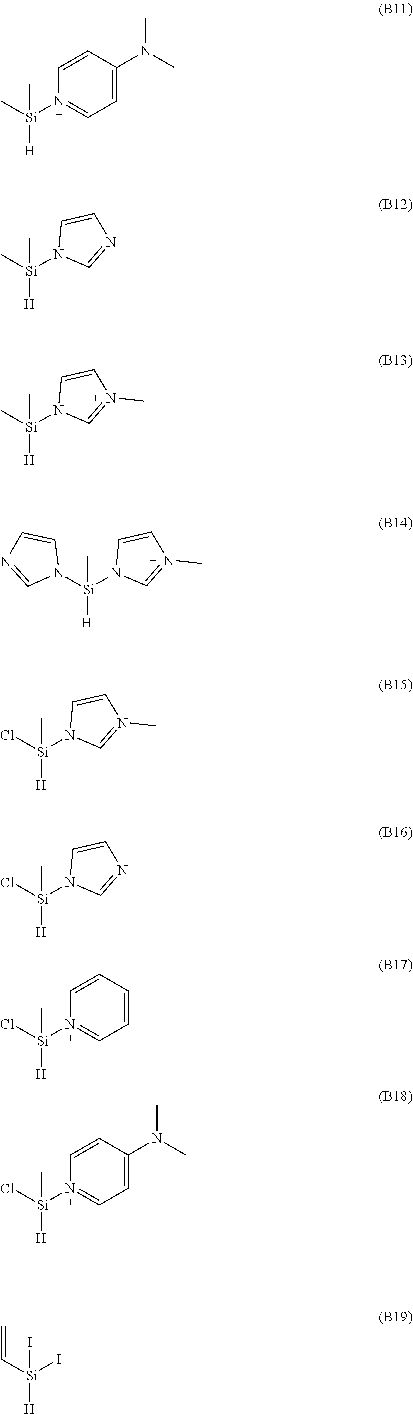 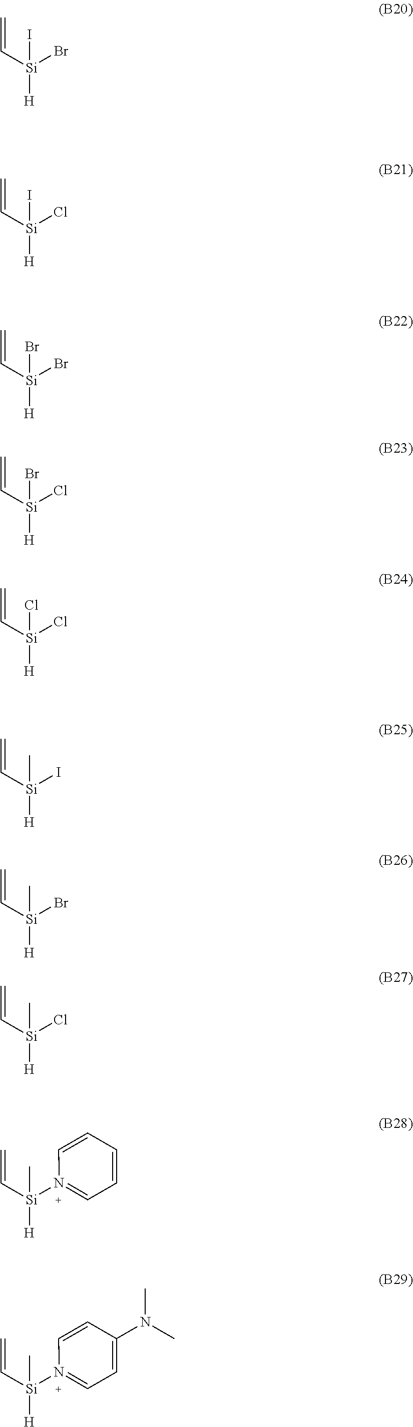 [chemical structure]
